(19) United States
(12) Patent Application Publication
(10) Pub. No.: US 2014/0033552 A1
(43) Pub. Date: Feb. 6, 2014

(54) APERTURE RATIO MEASUREMENT SENSING DEVICE

(71) Applicant: INDUSTRIAL TECHNOLOGY RESEARCH INSTITUTE, (US)

(72) Inventor: Chih-Jian HU, Hsinchu City (TW)

(73) Assignee: INDUSTRIAL TECHNOLOGY RESEARCH INSTITUTE, Hsinchu (TW)

(21) Appl. No.: 13/720,219

(22) Filed: Dec. 19, 2012

(30) Foreign Application Priority Data
Aug. 3, 2012 (TW) 101215002
Nov. 2, 2012 (CN) 201220574665.X

(51) Int. Cl. G01B 11/02; G01C 1/00

(52) U.S. Cl. CPC G01B 11/02; G01C 1/00
USPC 33/227

(57) ABSTRACT

An aperture ratio measurement sensing device is provided. The aperture ratio measurement sensing device comprising a light sensing module and a signal measurement module is used for measuring a distance/angle to which a motion object in a use state is moved/opened with respect to an opening portion. The light sensing module is disposed on a structure of a building near the motion object. The signal measurement module is used for measuring a light signal received by the light sensing module, and determining the aperture ratio of the opening portion according to the intensity of the light signal.

This application claims the benefits of Taiwan application Serial No. 101215002, filed Aug. 3, 2012 and People's Republic of China application Serial No. 201220574665.X, filed Nov. 2, 2012, the disclosures of which are incorporated by reference herein in its entirety.

### TECHNICAL FIELD

The disclosure relates in general to a sensing device, and more particularly to an aperture ratio measurement sensing device used in a building.

### BACKGROUND

Outdoor air is introduced to a building when an opening portion, such as a door or a window, is opened. The ventilation of air helps to improve the quality of air. If the air input is not under good control, the indoor temperature comfort and the power consumption in air-conditioning will be affected. Most people spend their time indoors. However, due to the consideration of power saving, modern buildings are getting more and more air-tight. As a result, the air input is insufficient to dilute the concentration of indoor pollutants, hence hazarding health.

Therefore, how to obtain an ideal air input considering the seasons, use of space and the number of people and control the degree and time of the opening portion of the building according to the temperature and air quality have become a focus in the design of green buildings.

### SUMMARY

The disclosure is directed to an aperture ratio measurement sensing device.

According to one embodiment, an aperture ratio measurement sensing device is provided. The aperture ratio measurement sensing device includes a light sensing module and a signal measurement module. The light sensing module is used for measuring a distance/angle to which a motion object in a use state is moved/opened with respect to an opening portion. The light sensing module is disposed on a structure of a building near the motion object. The signal measurement module is used for measuring a light signal received by the light sensing module, and determining the aperture ratio of the opening portion according to the intensity of the light signal.

According to one embodiment, the light sensing module includes a light transceiver, a light reflector, and a guider enabling the light transceiver and the light reflector to move relatively, a displacement of the light transceiver or the light reflector is equivalent to the distance/angle to which the motion object is moved/opened with respect to the opening portion.

According to another embodiment, the light sensing module includes a light emitter, a light receiver and a guider enabling the light emitter and the light reflector to move relatively, a displacement of the light emitter or the light receiver is equivalent to the distance/angle to which the motion object is moved/opened with respect to the opening portion.

The aperture ratio measurement sensing device disclosed in the disclosure is capable of determining an aperture ratio of an opening portion of a building or an opening distance formed by an object according to the intensity of a light signal and the changes in the sensing distance.

### BRIEF DESCRIPTION OF THE DRAWINGS

FIG. 1 shows a schematic diagram of an aperture ratio measurement sensing device according to an embodiment of the disclosure;

FIG. 2 shows a schematic diagram of an aperture ratio measurement sensing device according to another embodiment of the disclosure;

FIG. 3A and FIG. 3B respectively show schematic diagrams of a light sensing module with a position of a light transceiver and a position of a light reflector being interchanged;

FIG. 4 shows a schematic diagram of an aperture ratio measurement sensing device according to an embodiment of the disclosure;

FIGS. 5A˜5C show schematic diagrams of an aperture ratio measurement sensing device of the disclosure used in various window-shaped structures.

FIG. 6 shows a schematic diagram of an aperture ratio measurement sensing device according to an embodiment of the disclosure.

FIG. 7 shows a schematic diagram of an aperture ratio measurement sensing device according to an embodiment of the disclosure.

FIG. 8 shows a schematic diagram of an aperture ratio measurement sensing device according to an embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The operating principles and structures of the disclosure are elaborated below with accompanying drawings.

The present embodiment discloses an aperture ratio measurement sensing device which determines an aperture ratio of an opening portion of a building according to the relationship between the intensity of an outputted light signal and a sensing distance. Particularly, the sensing device measures a distance/angle to which a motion object is moved/opened to save power or adjust indoor temperature automatically. In a use state, the motion object, such as a door or a window, may be opened by an automatic power saving device or opened manually in the night time when the temperature is low, and may be closed in the day time when the temperature is high. Alternatively, air input is increased when it is detected that air quality is poor and is reduced when it is detected that air quality is good, so that the indoor/outdoor air is ventilated for adjusting the temperature difference between day time and night time and power consumption in air-conditioning can be saved. In an embodiment, the aperture ratio measurement sensing device comprises a light sensing module and a signal measurement module. The light sensing module dynamically measures the change in the intensity of a light. When a motion object, such as a door or a window, is shifted and causes the aperture ratio (or opening distance) to increase or decrease, the sensing distance between the light transceiver and the light reflector being driven by a connecting component (such as a pilot wire) synchronically increases or decreases, and the intensity of the light signal received by the light transceiver also synchronically changes according to the sensing distance between the light transceiver and the light reflector. Lastly, the light signal is transmitted to the signal conversion unit for subsequent processing and then is outputted by the signal output unit and used for determining the aperture ratio of the opening portion or the opening distance formed by a motion object such as a door or a window.

A number of embodiments are disclosed below for elaborating the disclosure. However, the embodiments of the disclosure are for detailed descriptions only, not for limiting the scope of protection of the disclosure.

### First Embodiment

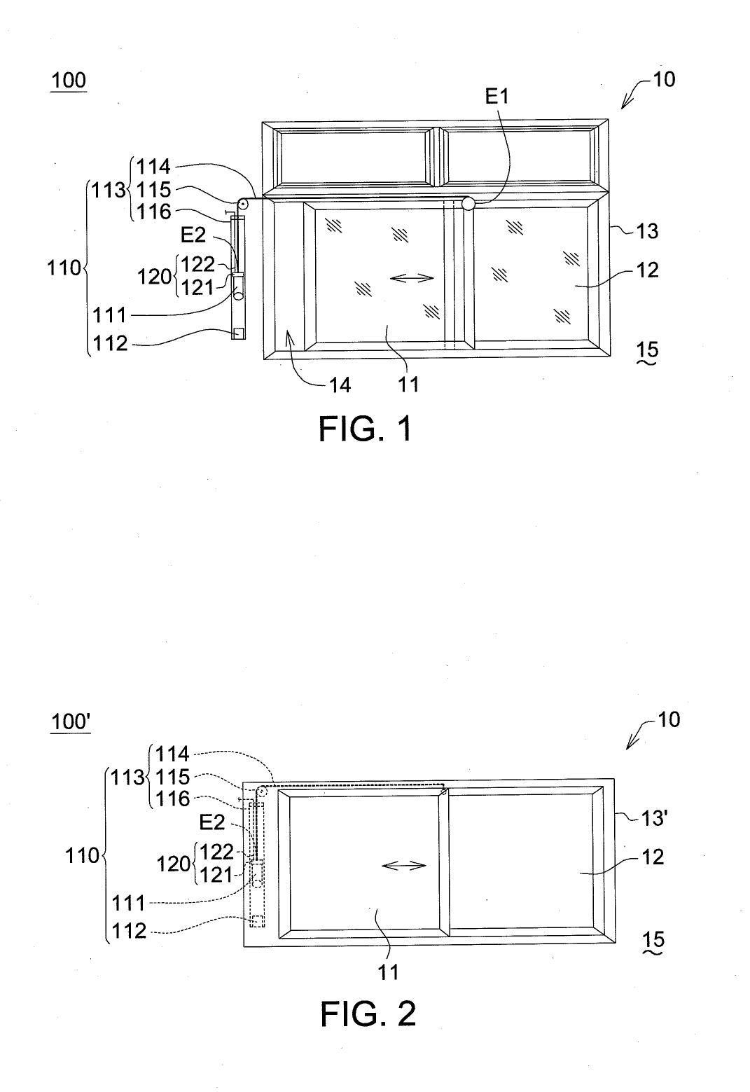

Referring to FIG. 1, a schematic diagram of an aperture ratio measurement sensing device according to an embodiment of the disclosure is shown. Let a slide type window-shaped structure 10 (or hung type window-shaped structure) be taken for example. Two glass windows 11 and 12 are fixed on a frame structure 13, and may be opened or closed along the edge of the window frame in a horizontal manner to change the positions of the glass windows 11 and 12. Suppose at least one of the two glass windows 11 and 12 is a motion object. When the two glass windows 11 and 12 are completely closed, the aperture ratio of the opening portion 14 is defined as 0. When the two glass windows 11 and 12 are opened and completely overlapped with each other, the aperture ratio of the opening portion 14 is defined as 100. Therefore, the aperture ratio of the window-shaped opening portion 14 may be changed by changing the positions of the glass windows 11 and 12.

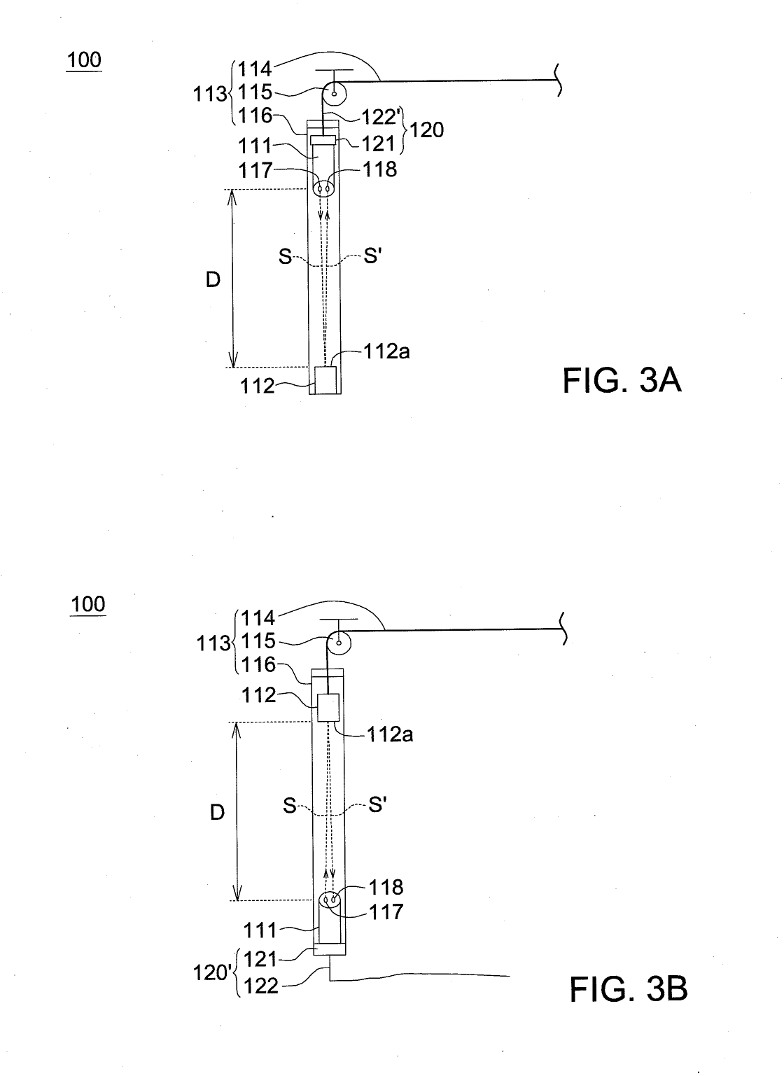

As indicated in FIG. 1, the aperture ratio measurement sensing device 100 includes a light sensing module 110 consisting of a light transceiver 111, a light reflector 112 and a guider 113. The guider 113 comprises a pilot wire 114, a supporter 115 and a tube 116. One end E1 of the pilot wire 114 is connected to the glass window 11. The supporter 115 is fixed on a moving path of the pilot wire 114. The tube 116 accommodates the light transceiver 111 and the light reflector 112. The other end E2 of the pilot wire 114 is connected to the light transceiver 111, so that the light transceiver 111 is driven by the pilot wire 114 and the glass window 11 to move inside the tube 116. The transmission end 117 of the light transceiver 111 emits a light signal S to the light reflector 112 along a long-axis direction of the tube 116, and the reception end 118 of the light transceiver 111 receives the light signal S′ reflected from the light reflector 112 as indicated in FIG. 3A.

As indicated in FIG. 3A, when the light transceiver 111 linearly moves with respect to the light reflector 112, the intensities of the light signals S and S′ are inversely proportional to a distance D between the light transceiver 111 and the light reflector 112. In an embodiment, the intensities of the light signals S and S′ can be inversely proportional to the square of the distance D. Therefore, when the distance D increases, the intensities of the light signals S and S′ relatively decrease; when the distance D decreases, the intensities of the light signals S and S′ relatively increase. In an embodiment, an opaque tube 116 or a tube 116 encapsulated with an opaque material is used so that the light signals S and S′ are less affected by the external light. Besides, the inner wall of the tube 116 can be coated with a high reflective material or processed with mirror treatment to avoid the light signals S and S′ being scattered or decaying, hence affecting the precision in reading the light signal. In the present embodiment, as long as the intensity of the light received at the reception end 118 of the light transceiver 111 varies with the relative distance of the light signal S, an optimum function can be obtained through a mathematic model, and an algorithm of the relationship between the distance D and the output signal can be performed to achieve precision measurement.

As indicated in FIG. 1, the tube 116 of the guider 113 is exposed and fixed on a structural wall 15 of the building near glass windows 11 and 12, and the long-axis direction of the tube 116 is substantially perpendicular to the ground. In addition, the supporter 115 and the pilot wire 114 are also exposed and fixed above the tube 116, and the pilot wire 114 is substantially parallel to an upper edge of the glass windows 11 and 12. One end E2 of the pilot wire 114 is connected to the light transceiver 111 along a lateral edge of the glass window 11. Under the influence of gravity or an external counterweight, the light transceiver 111 is vertically hung inside the tube 116. When one end E1 of the pilot wire 114 is driven by the glass window 11 and moves horizontally, the moving direction of the pilot wire 114 may be changed by the supporter 115. For example, the pilot wire 114 changes to move vertically, so that the light transceiver 111 in the vertical direction may move inside the tube 116 as indicated in FIG. 1.

The position of the light transceiver 111 and that of the light reflector 112 are interchangeable as indicated in FIG. 3B. That is, the other end E2 of the pilot wire 114 may be connected to the light reflector 112, so that the light reflector 112 moves relatively to the light transceiver 111 and the sensing distance D varies accordingly. Besides, although the supporter 115 is exemplified by a roller, the supporter 115 may also be realized by a hook fixed on the structural wall, a low-friction supporting ring or a low-friction bracket, so that the pilot wire 114 may freely move vertically or horizontally. In another embodiment, when the pilot wire 114 only moves one-way such as moving along the long-axis direction of the tube 116 without changing its moving direction, the assistance of the supporter 115 can be dispensed. Therefore, the embodiment in which the supporter 115 is used is not for limiting the implementations of the disclosure.

Referring to FIG. 2, a schematic diagram of an aperture ratio measurement sensing device 100′ according to another embodiment of the disclosure. The present embodiment is different from the above embodiment in that the tube 116 of the guider 113 is built-in and fixed on a frame structure 13′ surrounding the glass windows 11 and 12 such as being fixed on the window frame of the glass windows 11 and 12, and the long-axis direction of the tube 116 is substantially perpendicular to the ground. In addition, the supporter 115 and the pilot wire 114 are also built-in and fixed above the tube 116 and hidden in the frame structure 13′ parallel to an upper edge of the glass window 11. Therefore, when the pilot wire 114 is driven by the glass window 11 and moves horizontally, the moving direction of the pilot wire 114 may be changed by the supporter 115. For example, the pilot wire 114 changes to move vertically, so that the light transceiver 111 in the vertical direction may move inside the tube 116.

Referring to FIG. 3A and FIG. 3B. The transmission end 117 of the light transceiver 111 has a high directive light source, such as a light emitting diode powered by a battery or an external power, for emitting a visible light to the light reflector 112. The reception end 118 of the light transceiver 111 has a photoelectric device capable of measuring the change in the intensity of the light. For example, the photoelectric device is realized by a photodiode, a phototransistor or a photoresistor used for receiving the light signal S′ reflected from the light reflector 112.

The surface 112a of the light reflector 112 is such as a reflective mirror surface, or a reflective layer uniformly coated with a reflective material. For example, the reflective layer is a white opaque film.

The guider 113 makes the light transceiver 111 move relatively to the light reflector 112, so the displacement of the light transceiver 111 (or the light reflector 112) is equivalent to the distance/angle to which a motion object (such as a door or a window) is moved/opened with respect to the opening portion as indicated in two embodiments disclosed above. Detailed structures of the guider 113 are already disclosed above and the similarities are not repeated here.

As indicated in FIG. 3A and FIG. 3B, the signal measurement module 120 is used for outputting a light signal S′ received by the light transceiver 111. The signal measurement module 120 comprises a signal conversion unit 121 and a signal output unit 122.

When the intensity of the light signal S′ received by the light transceiver 111 synchronically increases or decreases along with the displacement of the light transceiver 111 (or the light reflector 112), the light signal S′ is photo-electrically converted to a current/voltage signal transmitted to the signal conversion unit 121 and then is outputted by the signal output unit 122. The output signal is such as a 0˜10V analog signal, and the algorithm of the relationship between the distance D and the output signal is performed to determine an aperture ratio of the opening portion 14 or an opening distance formed by a motion object.

As indicated in FIG. 3A, the signal measurement module 120 may move inside the tube 116 along with the light transceiver 111. Alternatively, the signal measurement module 120′ and the light transceiver 111 are fixed at the bottom of the tube 116 as indicated in FIG. 3B. Also, the signal measurement module may be fixed outside the tube 116 and then is connected to the light transceiver 111 through a signal line (not illustrated). The disclosure does not impose specific restriction regarding the disposition of the signal measurement module.

Besides, the conductive wire of the signal output unit 122 is used for outputting a signal or transmitting power. The pilot wire 114 may be realized by a pilot wire lacking signal transmission function or a signal line having signal transmission function. For example, the pilot wire 114 of FIG. 1 is made from nylon, and the pilot wire 114 and the conductive wire of the signal output unit 122 are arranged side by side and disposed in the upper space of the tube 116. In FIG. 3A, the pilot wire 114 and the signal output unit 122′ may be integrated as a pilot wire having both signal transmission function and signal guiding function. The pilot wire not only outputs a signal but also provides driving power to the light transceiver 111 and the signal measurement module 120.

### Second Embodiment

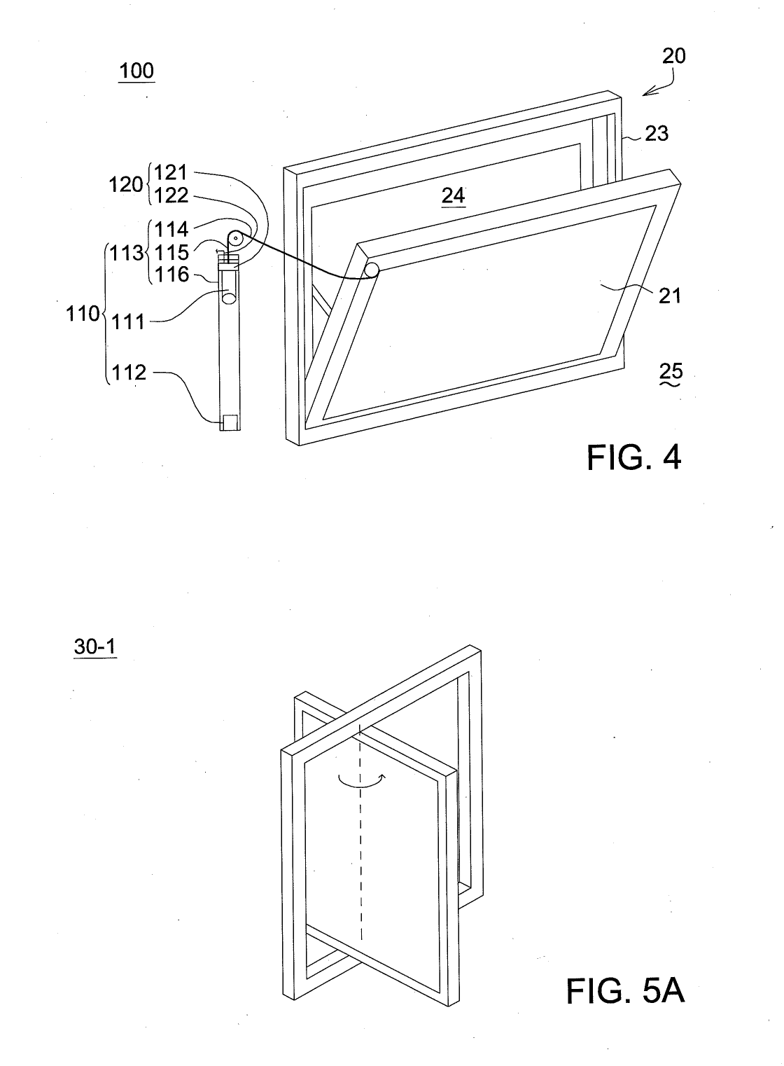

Referring to FIG. 4, a schematic diagram of an aperture ratio measurement sensing device according to an embodiment of the disclosure is shown. Let a hopper type window-shaped structure 20 (or an awning type window-shaped structure) be taken for example. A glass window 21 (a motion object) is fixed on a frame structure 23, and may be rotated to an angle around a horizontal line at the lower edge of the window frame to change the opening angle of the glass window 21. When the glass window 21 is completely closed, the aperture ratio of the opening portion 24 is defined as 0. When the glass window 21 is completely opened, the aperture ratio of the opening portion 24 is defined as 100. Therefore, the present embodiment may change the aperture ratio of the window-shaped opening portion 24 by changing the opening angle of the glass window 21.

The present embodiment is different from above embodiments in the way of opening the motion object. In the present embodiment, the light transceiver 111, the light reflector 112, the pilot wire 114 of the guider 113, the supporter 115 and the tube 116, the signal conversion unit 121 and the signal output unit 122 are disposed in the same way like the above embodiments except that the moving direction of the pilot wire 114 changes to a direction parallel to the normal line of the structural wall 25 from a horizontal direction. In an embodiment, the pilot wire 114, the supporter 115 and the tube 116 are exposed and fixed on a structural wall 25 of the building near the glass window 21. In another embodiment, the pilot wire 114, the supporter 115 and the tube 116 are built-in and fixed in a frame structure 23 surrounding the glass window 21. Therefore, the aperture ratio measurement sensing device of the disclosure may be integrated in the frame structure 23 and become a portion of the building opening structure.

Although the supporter 115 is exemplified by a roller, the supporter 115 may also be realized by a hook fixed on the structural wall, a low-friction supporting ring or a low-friction bracket, so that the pilot wire 114 may freely move vertically or horizontally. In another embodiment, when the pilot wire 114 only moves one-way such as moving along the long-axis direction of the tube without changing its moving direction, the assistance of the supporter 115 can be dispensed. Therefore, the embodiment in which the supporter 115 is used is not for limiting the implementations of the disclosure.

Besides, the pilot wire 114 and the signal output unit 121 may be independent from each other or may be integrated as a pilot wire having both signal transmission function and signal guiding function. The pilot wire 114 not only outputs a signal but also provides driving power to the light transceiver 111 and the signal measurement module 120.

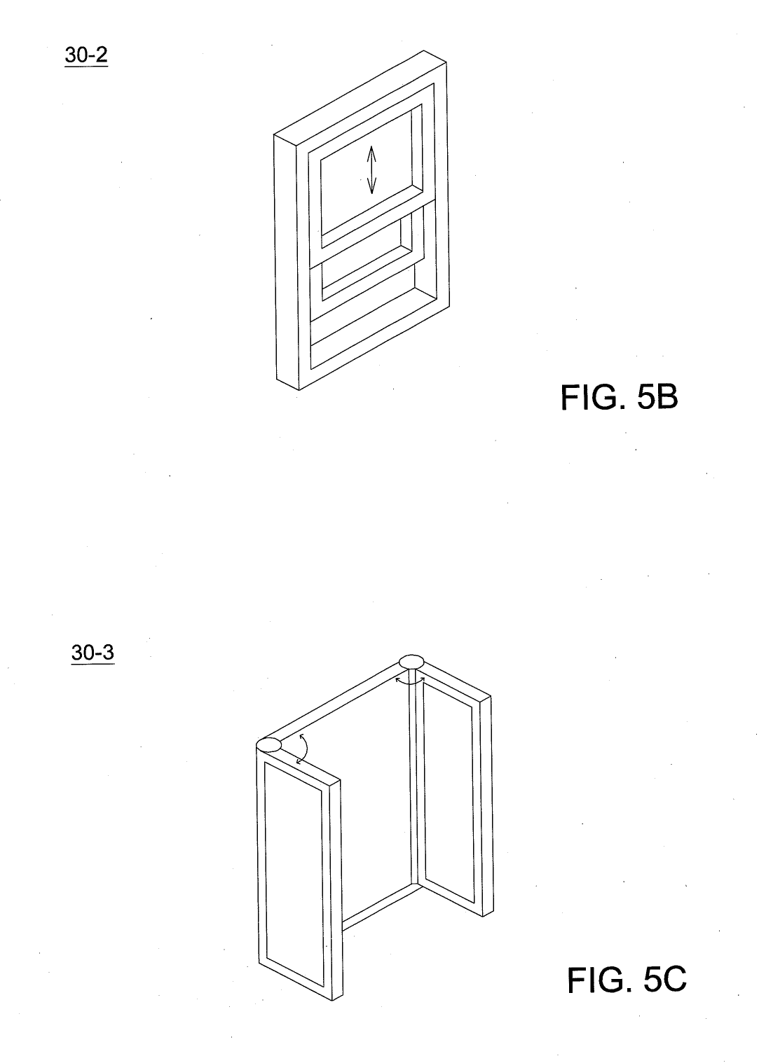

The above embodiments are exemplified by window-shaped structures 10 and 20. However, the sensing device may also be used in a door-shape structure or any opening or ventilation portions of a building. Apart from being used in slide type, hopper type, and awning type of window-shaped structures, the sensing device may also be used in center-pivot type (FIG. 5A), double or single hung type (FIG. 5B) and casement type (FIG. 5C) of window-shaped structures 30-1-30-3, and the details are not disclosed here.

### Third Embodiment

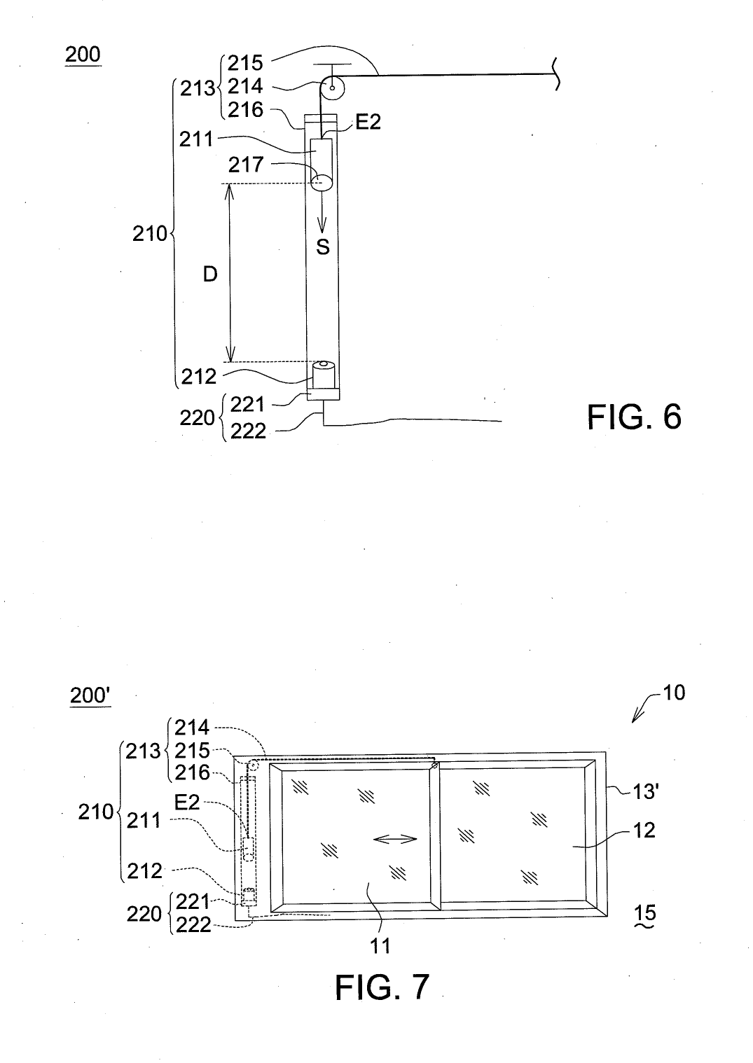

Referring to FIG. 6, a schematic diagram of an aperture ratio measurement sensing device 200 according to an embodiment of the disclosure is shown. As indicated in FIG. 6, the aperture ratio measurement sensing device 200 comprises a light sensing module 210 consisting of a light emitter 211, a light receiver 212 and a guider 213. The guider 213 comprises a pilot wire 214, a supporter 215 and a tube 216. The supporter 215 is fixed on a movement path of the pilot wire 214. The tube 216 accommodates the light emitter 211 and the light receiver 212. One end E2 of the pilot wire 214 is connected to the light emitter 211, so that the light emitter 211 is driven by the pilot wire 214 and the motion object (such as glass window) to move inside the tube 216. The light emitter 211 emits a light signal S to the light receiver 212 along a long-axis direction of the tube 216. When the intensity of the light signal S received by the light emitter 211 synchronically increases or decreases along with the displacement of the light emitter 211 (or the light receiver 212), the light signal S is photo-electrically converted to a current/voltage signal transmitted to the signal conversion unit 221 and then is outputted by the signal output unit 222.

The position of the light emitter 211 and that of the light receiver 212 are interchangeable. That is, the end E2 of the pilot wire 214 may be connected to the light emitter 211 or the light receiver 212, so that the light receiver 212 moves relatively to the light emitter 211 and the sensing distance D varies accordingly.

The light emitter 211 has a high directive light source 217, such as a light emitting diode powered by a battery or an external power, for emitting a visible light to the light receiver 212. The light receiver 212 has a photoelectric device capable of measuring the change in the intensity of the light. For example, the photoelectric device is realized by a photodiode, a phototransistor or a photoresistor used for receiving the light signal S transmitted from the light emitter 211.

Referring to FIG. 7, a schematic diagram of an aperture ratio measurement sensing device 200′ according to an embodiment of the disclosure is shown. The present embodiment is different from the above embodiment in that the tube 216 of the guider 213 is built-in and fixed in a frame structure 13′ surrounding the glass windows 11 and 12. In addition, the supporter 215 and the pilot wire 214 are also built-in and fixed above the tube 216 and hidden in the frame structure 13′ corresponding to an upper edge of the glass window 11. Detailed structures of the guider 213 are similar to those structures of the guider 113 in the first and second embodiments and the similarities are not repeated here.

### Fourth Embodiment

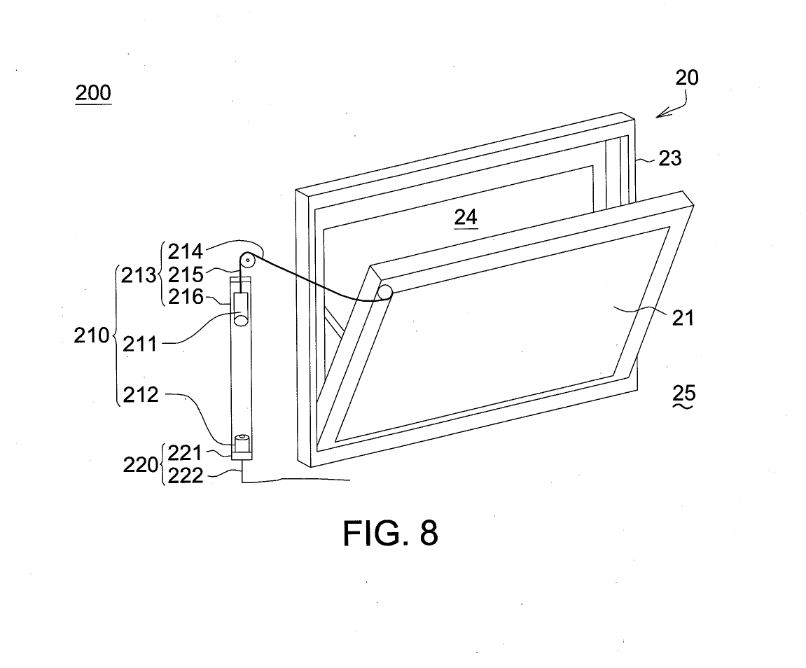

Referring to FIG. 8, a schematic diagram of an aperture ratio measurement sensing device 200 according to an embodiment of the disclosure is shown. The present embodiment is different from above embodiments in the way of opening the motion object. In the present embodiment, the light emitter 211, the light receiver 212, the pilot wire 214, the supporter 215 and the tube 216 of the guider 213, the signal conversion unit 221 and the signal output unit 222 are disposed in the same way like the above embodiments except that the moving direction of the pilot wire 214 changes to a direction parallel to the normal line of the structural wall 25 from a horizontal direction. In an embodiment, the pilot wire 214, the supporter 215 and the tube 216 are exposed and fixed on a structural wall 25 of the building near the glass window 21. In another embodiment, the pilot wire 214, the supporter 215 and the tube 216 are built-in and fixed on a frame structure 23 surrounding the glass window 21. Therefore, the aperture ratio measurement sensing device of the disclosure may be integrated in the frame structure 23 and become a portion of the building opening structure.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An aperture ratio measurement sensing device comprising:
a light sensing module for measuring a distance/angle to which a motion object in a use state is moved/opened with respect to an opening portion, the light sensing module is disposed on a structure of a building near the motion object; and
a signal measurement module for measuring a light signal received by the light sensing module, and determining the aperture ratio of the opening portion according to the intensity of the light signal.

2. The aperture ratio measurement sensing device according to claim 1, wherein the light sensing module includes a light transceiver, a light reflector, and a guider enabling the light transceiver and the light reflector to move relatively, a displacement of the light transceiver or the light reflector is equivalent to the distance/angle to which the motion object is moved/opened with respect to the opening portion.

3. The aperture ratio measurement sensing device according to claim 2, wherein the guider comprises a pilot wire connecting the light transceiver or the light reflector and the motion object.

4. The aperture ratio measurement sensing device according to claim 3, wherein, the guider comprises a supporter used for changing the moving direction of the pilot wire and fixed on a moving path of the pilot wire.

5. The aperture ratio measurement sensing device according to claim 4, wherein the supporter comprises a roller, a hook, a supporting ring or a bracket.

6. The aperture ratio measurement sensing device according to claim 2, wherein the guider comprises a tube used for accommodating the light transceiver and the light reflector, the light transceiver or the light reflector is driven by the pilot wire and the motion object to move inside the tube, and the light transceiver emits the light signal to the light reflector along a long-axis direction of the tube and receives the light signal reflected from the light reflector.

7. The aperture ratio measurement sensing device according to claim 2, wherein the guider is exposed and fixed on the structural of the building near the motion object.

8. The aperture ratio measurement sensing device according to claim 2, wherein the guider is built-in and fixed on a frame structure surrounding the motion object.

9. The aperture ratio measurement sensing device according to claim 2, wherein the signal measurement module comprises a signal conversion unit and a signal output unit, and the intensity of the light signal received by the light transceiver synchronically increases or decreases along with the displacement of the light transceiver or the light reflector, the light signal is photo-electrically converted and transmitted to the signal conversion unit and then is outputted by the signal output unit.

10. The aperture ratio measurement sensing device according to claim 1, wherein the light sensing module includes a light emitter, a light receiver and a guider enabling the light emitter and the light reflector to move relatively, a displacement of the light emitter or the light receiver is equivalent to the distance/angle to which the motion object is moved/opened with respect to the opening portion.

11. The aperture ratio measurement sensing device according to claim 10, wherein the guider comprises a pilot wire connecting the light emitter and the motion object.

12. The aperture ratio measurement sensing device according to claim 11, wherein the guider comprises a supporter fixed on a movement path of the pilot wire for changing the moving direction of the pilot wire.

13. The aperture ratio measurement sensing device according to claim 12, wherein the supporter comprises a roller, a hook, a supporting ring or a bracket.

14. The aperture ratio measurement sensing device according to claim 11, wherein the guider comprises a tube used for accommodating the light emitter and the light receiver, the light emitter or the light receiver is driven by the pilot wire and the motion object to move inside the tube, and the light emitter emits the light signal to the light receiver along a long-axis direction of the tube.

15. The aperture ratio measurement sensing device according to claim 10, wherein the guider is exposed and fixed on the structural of the building near the motion object.

16. The aperture ratio measurement sensing device according to claim 10, wherein the guider is built-in and fixed on a frame structure surrounding the motion object.

17. The aperture ratio measurement sensing device according to claim 10, wherein the signal measurement module comprises a signal conversion unit and a signal output unit, and the intensity of the light signal received by the light receiver synchronically increases or decreases along with the displacement of the light emitter or the light receiver, the light signal is photo-electrically converted and transmitted to the signal conversion unit and then is outputted by the signal output unit.

18. The aperture ratio measurement sensing device according to claim 1, wherein the intensity of the light received by the light sensing module varies with the distance or the angle.

19. The aperture ratio measurement sensing device according to claim 18, wherein the intensity of the light signal is inversely proportional to the distance or the angle.
